(19) United States
(12) Patent Application Publication
(10) Pub. No.: US 2005/0280212 A1
(43) Pub. Date: Dec. 22, 2005

(54) Counter sorting device

(76) Inventors: Ernst Blaha, Irenentalstrasse (AT); Peter Krenn, Wohnpart Kery (AT)

Correspondence Address: MARK A. LITMAN & ASSOCIATES, P.A.;York Business Center, 3209 W. 76th St.,Suite 205, Edina, MN, 55435, US

(21) Appl. No.: 11/004,006

(22) Filed: Dec. 3, 2004

(30) Foreign Application Priority Data
May 26, 2003 (WO) WO 03/103860
Jun. 5, 2002 (AT) GM 359/02

(51) Int. Cl. A63F 1/00; A63F 9/20; G05G 1/00; G07F 7/00; G07F 1/06

(52) U.S. Cl. 273/292; 194/205; 194/214

(57) ABSTRACT

A sorting device for the sorting of gaming chips comprises a base frame (36), a collection container (1), an oblique transport disc (3) adjoining the collection container (1), the oblique transport disk (3) separating and receiving gaming chips (27), a gaming chip characteristic identification system positioned adjacent the transport disc (3), a transfer device (11) distributing the gaming chips (27) in removal units (12) according to characteristics identified in the gaming chip characteristic identification system. The sorting device has a transport for transferring the gaming chips directly from the transport disc (3) to the removal units (12), and a radially external region of the transport disc (3) contains recesses (8) into which the gaming chips are separated. The sorting device is provided with at least one ejector (14) that can be inserted at least partially from one side of the transport disc (3) into the recesses (8) to lift an edge (15) of the gaming chips (27) above a front face of the transport disc (3) lying opposite the at least one ejector (14), whereby a blade (16) located on a removal unit (12) slides under the gaming chip (27) with a lifted edge, and the gaming chip (27) with a lifted edge is placed on the blade.

The Invention refers to a chip-sorting device for gaming chips and counters, specifically those of varying colors and according to the overall concept of Claim 1.

Sorting devices for gaming chips have been well known for a long time. In GB2061490, a patent for a sorting device was published, whereby gaming chips were grasped by a conveyor chain and passed by a characteristic recognition system. This approach is disadvantageous in its requirement for considerable space, specifically for the chain. It is further disadvantaged by the high manufacturing costs, as the chain is comprised of many individual links that are additionally provided with spring-loaded bolts, for the dispensing of the gaming chips.

GB2254419 describes a sorting device, whereby the gaming chips are held by a transport disc and subsequently transferred to a chain, where they are recognized and gathered together, to be distributed. This arrangement requires less space than the aforementioned. This relies upon elastic components in order to hold individual chips for transfer from the disc to the chain and in the chain itself. It is these elastic elements that permit only certain-sized chips to pass through—the gaming chips that are larger than the designated threshold diameter are a mechanical burden/load to the system and are never distributed/transferred to the chain. The gaming chips smaller than the designated diameter cannot be grasped by the chain; therefore, additional chain is necessary, leading to higher manufacturing costs.

U.S. Pat. No. 6,381,294 is a well-known chip-sorting device whereby the advancement of the chips is brought about by a chain that is expensive to maintain.

The goal of this Invention is avoiding these disadvantages and putting forth a chip-sorting device of a different type, which has lower manufacturing costs and utilizes less space, and thereby, is able to handle sorted gaming chips and counters of vastly differing dimensions.

Consistent with such an Invention would be this Sorting Plan/Proposal that introduces the aforementioned type of device that achieves the designated characteristics of Claim 1.

Through the proposed measures, there is the possibility to advance and sort gaming chips and counters of varying dimensions, using a cost efficient and simple method. The technically expensive and maintenance-intensive use of the chain is not advantageous. That sorting device is not sensitive to the varied sizes of gaming chips and counters. During the elevation of the chips and the simultaneous rotation of the transport disc, the chips are automatically removed from the transport disc and organized within removal units.

Thereby, there is, through the features in Claims 2 and 3, the advantage of clean and gentle delivery of the chips into the removal units.

The features in Claim 4 render it certain that the distribution movement for a single gaming chip or counter, relative to the movement of the transport disc, is always constant, even when the transport speed is altered/adjusted.

Through the features in Claim 5, the organization of the gaming chips, in conjunction with the characteristic recognition system, can be easily programmed and regulated.

Through the features of Claim 6, several removal discs can be loaded.

Through the features of Claim 7, it is possible that a portion of the sorted gaming chips and counters may be easily and readily removed from the removal units.

Through the features of Claims 8 and 9, the number of gaming chips and counters removed from the removal units can be set.

Toward this end, the movement arc of the removal lever, with reference to Claim 10, is anticipated.

Through the features of Claim 11, the removal lever lies in close proximity to the gaming chips and counters.

Through the features of Claim 12, it can be reliably determined when a removal unit has reached full capacity.

Based upon the designated characteristics of Claim 13, the rate of advancement/transport of the gaming chips and counters is appropriate for the system.

The designated characteristics of Claims 14 and 15 describe the characteristic recognition system that is preferably employed.

Through the designated characteristics of Claim 16, the base frame has the capability to be adjusted for varying table heights.

The Invention is better illustrated by the drawing/diagram.

FIG. 1 A schematic drawing of the invention without its housing.

FIG. 2 A cross-section through the removal unit.

FIG. 3 A cut through the chip distribution unit.

FIG. 4 A possible enlarged view of the removal units.

FIG. 5 An alternative depiction of the collection disc.

The device consists of a collection container (1) (a/k/a hopper), open from above, for played gaming chips and counters, attached to the base frame (2).

The advancement/transport outfitting is comprised of a circular collection disc (3), and is mounted tightly on a drive axle. The axle (4) is housed in the base frame and is connected to the motor.

The collection disc (3) is driven by a number of cylinder bodies/rollers (6) housed in caged frames (7) and arrayed axially. This axial array may be overridden if the central axle (4) is frozen.

In practice, the gaming chips and counters (27) are collected in the hopper (1), where they fall to the lowest point/bottom by gravity and are taken up within circular openings (8) in the collection disc (3). The openings in the collection disc display at least the diameter of the largest chips for processing of the desired round gaming chips or counters. The depth of the cavities is set by the thickness of the collection disc. By the use of round holes, the gaming chips and counters (27) slide into the holes during the rotation of the collection disc (3) onto the base frame (2). FIG. 5 demonstrates an alternative collection of gaming chips and counters in sack holes, which open on the side of the hopper and are enclosed on the side of the base frame. Thereby, the back of the collection disc must have a circular groove (10) that is approximately the width of the ejector (14).

The collection disc (3) advances the gaming chips and counters (27) optionally serially/in rows at an angle of approximately 135 degrees from above; whereby, they are passed before a color sensor, which detects the combination of color and size variations. Depending upon chip color and design, the sensor conveys a signal to the regulating microprocessor. This regulating microprocessor decides, based upon programmable organization of colors, upon routing the gaming chips and counters (27) into the appropriate removal units.

Alternatively, recognition of the gaming chips and counters (27) can be achieved through a spectrometer in the characteristic recognition system, which differentiates based upon wavelength undetectable to the human eye. In order to accomplish this, the gaming chips and counters must be pigment coded.

After recognition, the distribution of the gaming chips and counters (27) into the removal units (12) is effected. This activity covers about 90 degrees of the collection disc (3).

FIG. 4 demonstrates, as an arc-like portion of the delivery device (11), the display of a number of openings (13), in which different gaming chips and counters (27) are sorted from the collection disc (3) into removal units (12). In this detailed example, 10 openings are used.

The actual distribution of gaming chips and counters is well viewed in FIG. 3, shown as a cut along the line (AA) from FIG. 2 through one of the openings (13) in the delivery device (11). Each of the openings (13) is arranged with an ejector (14), which after activation is inserted into the recesses (8) through a slit (38) in the base frame (2). The collection disc (3) lifts the specific gaming chip or counter. The ejector (14) is mounted so that it may swivel around the axle (17) and, via spring (18) action, is pushed against the cam (19). A roller/cylinder (20) facilitates the free closure of the cam (19) against the ejector (14).

Through continuous movement of the collection disc (3), the gaming chips or counters (27) are pushed onto the blade (16), where they rest/remain. As another counter (21) finds itself on the blade, it is ultimately lifted, and the earlier counter is placed underneath the latter. This process repeats until the removal unit (12) is filled with gaming chips or counters (27) of the same type.

FIG. 4 demonstrates the removal units (12) directly adjacent to the delivery device (11)—these units go, in practical fashion, from an arc-like arrangement, with respect to the device (11), to a straight or nearly straight arrangement next to one another to facilitate the easy removal of gaming chips or counters from all sides.

In FIG. 1, the drive assembly of the cam (19) is visible. With reference to the collection disc (3), the side of this disc away from the collection container (1) contains a ring-formed gear rim (22) that drives the pinion (23) and cam. The microprocessor establishes the magnetic coupling (24) between the cam and the pinion. It is assured that the ejector (14) has the same movement relative to the collection disc (3), which is independent of the speed of the collection disc (3).

In case of a jam during the transfer of the gaming chips and counters into the removal units, a brief decline/drop of the collection disc (3) may be anticipated. Toward recognition of a jam, the power of the motor (5) may be monitored, or the sensor of the collection disc (3) may be queried/assessed.

Toward the furtherance of the transport function and the simultaneous reduction of wear-and-tear on all the moving parts of the machine, it is recommended that suitable transport speed of the machine be maintained, with respect to the quantity of gaming chips and counters to be sorted. The setting of the speed can influence the rate (if and how many) of free chips, that is, not in the recesses (8) of the collection disc (3).

The removal units (12) for sorted gaming chips and counters are visible in FIG. 2 and are comprised of open-top chip transporters, each respectively provided with a central groove (25). For practical removal of gaming chips and counters (27) from the removal units, there is a specialized device provided—“Cutter” (26), which glides through the groove via gravity underneath to where the reserve gaming chips and counters are located in the removal units. The Cutter contains a L-shaped developed/advanced lever (28), whose thinner arm (26) lies underneath the gaming chips and counters. At the same time, a press (29) is always applied to the gaming chips and counters and props/supports itself, for its part, via an adjustable screw (30). The parts (28) and (29) are able to swivel and are connected via the axle (31) with the main bodies (32) gliding within the groove. Through pressure applied in the direction of arrow A, a specific quantity of gaming chips, preferably 20 pieces of gaming chips or counters, can be picked up by the lower arm (28a) of the L-shaped lever and are thus free to be taken away from the accumulation of gaming chips and counters (27).

With the adjustable screw (30), the quantity of gaming chips and counters lifted out by the “Cutter” (26) can be finely adjusted/regulated.

The insertion of a pressure spring (33) assures that the thin shank of the L-shaped lever (28) remains underneath the counters; however, it is not absolutely required.

In order to prevent overfilling of the removal units (12) with gaming chips or counters, every removal unit (12) is provided with a sensor (35). As soon as the “Cutter” (26) reaches its endpoint, a sensor delivers a signal to the microprocessor regulation, which prevents further delivery of gaming chips and counters (27) to the unit in question. The sensor (35) can, for example, be either an optical or magnetic sensor. In order to achieve this, a permanent magnet (34) must be embedded in the floor of the “Cutter” (26).

The device can be adjusted to different heights with a variety of means. In FIG. 1, the casters (37) on the base frame (36) are extremely adjustable.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A sorting device for the sorting of gaming chips comprising a base frame (36), a collection container (1), an oblique transport disc (3) adjoining the collection container (1), the oblique transport disk (3) separating and receiving gaming chips (27), a gaming chip characteristic identification system positioned adjacent the transport disc (3), a transfer device (11) distributing the gaming chips (27) in removal units (12) according to characteristics identified in the gaming chip characteristic identification system, removal units (12) having a U-shaped cross-section; the sorting device having a transport for transferring the gaming chips directly from the transport disc (3) to the removal units (12), and a radially external region of the transport disc (3) containing recesses (8) into which the gaming chips are separated, the sorting device provided with at least one ejector (14) that can be inserted at least partially from one side of the transport disc (3) into the recesses (8) to lift an edge (15) of the gaming chips (27) above a front face of the transport disc (3) lying opposite the at least one ejector (14), whereby a blade (16) located on a removal unit (12) slides under the gaming chip (27) with a lifted edge, and the gaming chip (27) with a lifted edge is placed on the blade.

18. The sorting device of claim 17 wherein the edge that is lifted is a lower edge.

19. The sorting device of claim 17 the ejector comprising an L-shaped lever having two arms comprising a longer arm (28a) and a shorter arm (29), the shorter arm (14a) positioned for insertion into the recesses (8).

20. The sorting device of claims 17 wherein turning movement of an ejector (8) is steered over a cam (19).

21. The sorting device of claim 17 wherein a side of the transfer disc (3) not adjacent to this container has a cogwheel (22).

22. The sorting device of claim 21 comprising adjacent the cogwheel (22) is a coupling (24).

23. The sorting device of claim 22 wherein there is a cam (19) that drives a pinion (23) adjacent the coupling (24).

24. The sorting device of claim 22 wherein the coupling (24) comprises a magnetic coupling (24).

25. The sorting device of claim 24 wherein the magnetic coupling (24) is activated by a microprocessor.

26. The sorting device of claim 17 wherein at least one removal unit (12) and ejector (14) is arrayed with a magnetic coupling (24) and pinion (23).

27. The sorting device of claim 1 wherein at least one removal unit (12) comprises an L-shaped removal lever (28) having a longer arm (28a), which longer arm (28a) is in a groove that runs a length of a floor of the removal unit (12) and goes under an area where the gaming chips (27) are supported.

28. A sorting device according to claim 19 wherein the shorter arm (29) of the removal lever (28) is moveable in the direction of the longer arm (28b).

29. The sorting device of claim 19 wherein movement of the shorter arm (29) along the longer arm (28b) is governed by an adjustable screw (30).

30. The sorting device of claim 19 wherein the removal lever (28) may swivel around an axle (31) at a parallel level to a movement direction of the shorter arm (29).

31. The sorting device of claim 19 wherein that the shorter arm (29) of the removal lever (28) encounters a spring (33), which pushes the shorter arm (29) against the gaming chips (27).

32. The sorting device of claim 1 wherein at least one removal unit (12) has a sensor (35) to detect when the removal unit (12) is at a full level.

33. The sorting device of claim 1 wherein the recognition system utilizes sensors to differentiate size and color combinations of gaming chips (27).

34. The sorting device of claim 1 further comprising a spectrometer in the characteristic recognition system to differentiate wavelengths of colors.

35. The sorting device of claim 1 wherein a base frame (36) is on casters (37).
